(19) United States
(12) Patent Application Publication
(10) Pub. No.: US 2004/0062570 A1
(43) Pub. Date: Apr. 1, 2004

(54) Image forming apparatus

(75) Inventor: Takaaki Hachisuga, Yokohama-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/254,784

(22) Filed: Sep. 26, 2002

(51) Int. Cl. G03G 15/01

(52) U.S. Cl. 399/226; 399/227; 399/302

(57) ABSTRACT

The color copying machine includes a photosensitive drum on which an electrostatic latent image is to be formed by light exposure, a revolver rotating such that a plurality of first developing devices are selectively placed so as to face the drum surface, a second developing device, an intermediate transfer member which superposes developing agent images formed on the drum surface and which transfers the superposed developing agent images, a conveyance passage which conveys a transfer medium toward the intermediate transfer member, and a transfer unit which transfers a developing agent image transferred to the intermediate transfer member onto the transfer medium conveyed through the conveyance passage. The revolver housing a plurality of first developing devices and the second developing device are arranged at positions outside the area above the photosensitive drum. The conveyance passage goes through a position outside the area below the revolver and the second developing device.

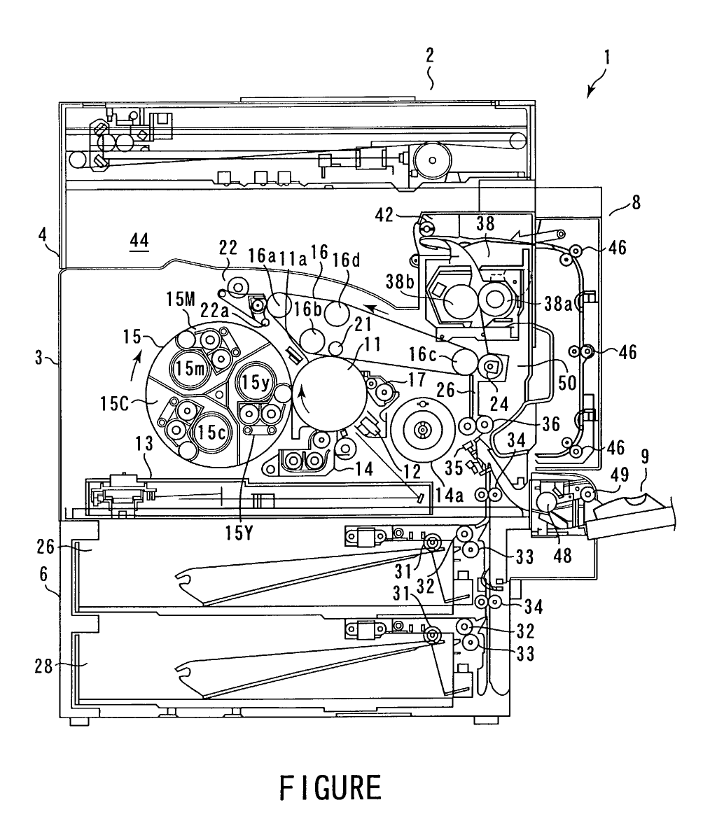

### BACKGROUND OF THE INVENTION

The present invention relates to an image forming apparatus such as a color printer and a color copying machine forming a color image on a paper sheet.

As an example of the image forming apparatus forming a color image on a paper sheet, a color laser printer disclosed in Japanese Patent Application No. 11-84801 has been known.

The laser printer has an image carrier on which a latent image is to be formed by light exposure, a plurality of developing devices which supply predetermined color developing agents to develop the latent image, an intermediate transfer member which transfers developing agent images of individual colors superposed on the image carrier, a transfer unit which transfers the transferred developing agent images superposed on the intermediate transfer member to a paper sheet by one operation, and a cassette storing a plurality of paper-sheets.

The yellow, magenta, and cyan developing devices are set in a developing unit rotary, which is rotatably arranged next to the image carrier. The black developing device is arranged discretely from the developing unit rotary and above the image carrier so as to face the image carrier. The developing unit rotary houses three color developing devices arranged side by side along the circumference. A specific color developing device is allowed to face the image carrier by rotating the developing unit rotary.

The intermediate transfer member is rotated and brought into contact with the lower portion of the image carrier.

The transfer material unloaded from a cassette is conveyed through a conveyance passage extending virtually horizontally below the intermediate transfer member and passed through the intermediate transfer member. At that time, the superposed developing agent images collectively transferred on the intermediate transfer member are transferred onto the transfer material by the transfer unit.

Such a conventional printer having the aforementioned structure has the following problems.

First, since the black developing device is arranged above the image carrier, undesirably scattered developing agent from the developing device falls down on the image carrier. The developing agent deposited on the image carrier is then transferred onto a paper sheet through the intermediate transfer member, forming a defective image.

Second, since a paper sheet is conveyed through the conveyance passage arranged below the intermediate transfer member, the developing agent undesirably scattered from each of developing devices set in the developing unit rotary and a developing agent scattered from the black developing device fall down on the paper sheet conveyed through the conveyance passage, forming a defective image.

### BRIEF SUMMARY OF THE INVENTION

The present invention was attained in view of the aforementioned points. An object of the present invention is to provide an image forming apparatus capable of preventing a defective image due to deposition of a developing agent and miniaturizing the structural elements.

To attain the aforementioned object, an image forming apparatus according to an embodiment of the present invention comprises

an image carrier on which a plurality of latent images are repeatedly formed;

a developing unit which houses a plurality of first developing devices, each containing a predetermined color developing agent, arranged side by side in a rotation direction, which is rotatably arranged such that the plurality of first developing devices are selectively placed so as to face the image carrier at a position outside an area above the image carrier, and which supplies a specific color developing agent to the latent image to develop the latent image;

a second developing device which is arranged so as to face the image carrier at a position outside the area and which supplies a predetermined color developing agent to the latent images to develop the latent images;

an intermediate transfer member which is arranged in contact with the image carrier and which superposes developing agent images developed by at least one of the first developing device and the second developing device and transfers the superposed developing agent image;

a conveying unit which conveys a transfer medium toward the intermediate transfer member; and

a transfer unit which transfers the superposed developing agent image transferred onto the intermediate transfer member to the transfer medium conveyed by the conveying unit.

In another aspect, an image forming apparatus according to an embodiment of the present invention comprises:

an image carrier of virtually cylindrical form on an outer circumference surface of which a latent image is to be formed;

a developing device which is arranged at a position outside an area above the image carrier so as to face the outer circumference surface of the image carrier and which supplies a developing agent to the latent image to develop the latent image;

an endless intermediate transfer belt which is rotatably arranged above and in contact with the outer circumference surface of the image carrier and which transfers a developing agent image developed by the developing unit;

a conveying unit which conveys a transfer medium toward the intermediate transfer belt; and

a transfer unit which transfers the developing agent image transferred on the intermediate transfer belt to the transfer medium conveyed by the conveying unit.

In still another aspect, an image forming apparatus according to an embodiment of the present invention comprises:

an image carrier on which a plurality of latent images are repeatedly formed;

a developing unit which houses a plurality of developing units, each containing a predetermined color developing agent, arranged side by side in a rotation direction, which is rotatably arranged such that the plurality of developing units are selectively placed so as to face a side surface of the image carrier, and which supplies a specific color developing agent to the latent image to develop the latent image;

an endless intermediate transfer belt which is arranged above and in contact with the image carrier and which superposes development agent images developed by the developing unit and transfers the superposed development agent image;

a conveying unit which conveys a transfer medium toward the intermediate transfer belt through a conveyance passage vertically extended at an opposite side of the image carrier to the developing unit; and

a transfer unit which transfers the superposed developing agent image transferred on the intermediate transfer belt to the transfer medium conveyed through the conveyance passage.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawing, which is incorporated in and constitutes a part of the specification, illustrate embodiments of the invention, and together with the general description given above and the detailed description of the embodiments given below, serve to explain the principles of the invention.

The single FIGURE is a schematic view of an interior structure of a copying machine according to the embodiment of the present invention.

### DETAILED DESCRIPTION

Now, the embodiment of the present invention will be explained in detail with reference to the accompanying drawing.

The shingle FIGURE shows a schematic view of an interior structure of a color copying machine 1 serving as an image forming apparatus according to the embodiment of the present invention.

A color-copying machine 1 has a scanner unit 2, a process unit 4, and a paper feed unit 6. In the scanner unit 2, an original document placed on a document glass (not shown) is irradiated with light, reflection light from the original document is guided to a light-receiving element through a plurality of optical members, and photoelectrically converted to output image data. In the process unit 4, the image data read out from the original document by the scanner unit 2 or an image based on the image data input through an exterior unit (not shown) is output on a paper sheet P (transfer medium). The feed unit 6 feeds the paper sheet P to the process unit 4.

The color-copying machine 1 has a case 3 housing the aforementioned units. To the right-hand side of the case 3 in the FIGURE, a reverse unit 8 and a manual feed unit 9 are detachably provided. The reverse unit 8 serves to turn over the paper sheet P having an image formed on one side thereof in a process unit 4 and then sends again back to the process unit 4. The manual feed unit 9 is used for feeding a paper sheet P by hand to the process unit 4.

More specifically, the process unit 4 has a photosensitive drum 11 (image carrier) having an axis extending in the front-rear direction (facing the drawing paper) of the color-copying machine 1. The photosensitive drum 11 is surrounded by a charging unit 12, a light exposure unit 13, a black developing device 14 (second developing device), a revolver 15 (developing unit), an intermediate transfer belt 16 (intermediate transfer member), and a drum cleaner 17 (cleaning unit), which are arranged in the rotation direction of the photosensitive drum 11 (indicated by an arrow in the FIGURE). It is necessary for the photosensitive drum 11 to have a diameter of at least 50 mm so as to arrange these units around it.

The charging unit 12 is responsible for charging the outer circumference surface 11a of the photosensitive drum 11 (hereinafter, referred to as a “drum surface 11a”) up to a predetermined potential. The light-exposure unit 13 is arranged at a position near the lower edge of the process unit 4 and responsible for exposing the drum surface 11a charged with the predetermined potential to light to form an electrostatic latent image based on image data. When a color image is formed, the drum surface 11a is exposed to light by the light-exposure unit 13 based on color separation image data, thereby forming electrostatic latent images of individual colors on the drum surface 11a.

The black developing device 14 is arranged between the photosensitive drum 11 and the light exposure unit 13, more specifically, under the photosensitive drum 11 so as to face the lower portion of the photosensitive drum 11. The black developing device 14 supplies a black developing agent to a latent image for black formed on the drum surface 11a by the light exposure unit 13, thereby developing the latent image to form a black developing agent image on the drum surface 11a. The black developing device 14 has a mixer, which supplies a developing agent while agitating, and a developing roller arranged so as to face the drum surface 11a with a predetermined development gap interposed between them. The black developing device 14 is rotatably arranged so as to bring the developing roller into contact with or separate from the drum surface 11a. The black developing device 14 is fed with a developing agent from the toner cartridge 14a.

The revolver 15 is rotatably arranged on the left hand side of the photosensitive drum 11 in contact therewith. The revolver 15 houses a yellow developing device 15Y (first developing device), a magenta developing device 15M (first developing device), and a cyan developing device 15C (first developing device), each basically having the same structure as that of the black developing device 14. The developing devices are arranged side by side in the rotation direction of the revolver 15 and detachably housed in the revolver 15. These developing devices have toner cartridges 15y, 15m, and 15c containing yellow, magenta and cyan color developing agents, respectively. Each of the developing devices 15Y, 15M, and 15C is selectively brought into the position facing the drum surface 11a from the side of the photosensitive drum 11 by rotating the revolver 15 clockwise.

The black developing device 14 is more frequently used than other color developing devices. Therefore, the black developing device 14 is arranged discretely from the revolver 15 housing these other color developing devices. By this arrangement, the amount of developing agent contained in the toner cartridge of the black developing device and the content of the developing device can be varied from those of the other color developing devices, thereby reducing the number of maintenance times including toner supply.

Since the black developing device 14 and the revolver 15 of this embodiment are arranged outside the area above the photosensitive drum 11, as described above, the developing agents undesirably scattered from individual developing devices 14, 15Y, 15M, and 15C can be prevented from falling on the photosensitive drum 11.

The intermediate transfer belt 16 is rotatably arranged above the photosensitive drum 11 so as to be in contact therewith. The intermediate transfer belt 16 is stretched around a drive roller 16a, a pretransfer roller 16b, a transfer opposed roller 16c, and a tension roller 16d, each having a rotatory shaft extending in the front-rear direction. More specifically, the drive roller 16a is fixed to the case 3 above the revolver 15. The pretransfer roller 16b is fixed to the case 3 above the photosensitive drum 11. The transfer opposed roller 16c is fixed at a position in contact with a vertical conveyance passage (described later). The tension roller 16 is urged outward from the interior of the belt 16 so as to give a predetermined tension to the intermediate transfer belt 16.

Inside the intermediate transfer belt 16, a primary transfer roller 21 is arranged for bringing the intermediate transfer belt 16 into contact with the drum surface 11a and simultaneously transfers a developing agent image formed on the drum surface 11a onto the intermediate transfer belt 16. The primary transfer roller 21 is urged toward the photosensitive drum 11 so as to press the intermediate transfer belt 16 against the drum surface 11a at a predetermined pressure.

Incidentally, the length of the intermediate transfer belt 16 is set at just an integral multiple of the outer circumference of the photosensitive drum 11. In other words, the length of the intermediate transfer belt 16 is set such that the same position of the drum surface 11a is always brought into contact with the same position of the belt 16. It is required for the intermediate transfer belt 16 to have the length exceeding at least the maximum length of a paper sheet P (431.8 mm). The photosensitive drum 11 requires a diameter exceeding at least 50 mm. In this embodiment, the intermediate transfer belt 16 is set so as to have a minimum length, that is, three times the length of the outer circumference of the photosensitive drum 11.

The intermediate transfer belt 16 is surrounded by a belt cleaner 22 (cleaning unit), and a secondary transfer roller 24 (transfer unit), each of which is arranged such that it can be brought into contact with and separated from the belt surface. The belt cleaner 22 is arranged above the revolver 15 and on the outer circumference of the drive roller 16a with the intermediate transfer belt 16 interposed between them. In other words, the belt cleaner 22 is arranged outside the area above the photosensitive drum 11. The secondary transfer roller 24 is arranged at a position so as to sandwich a vertical conveyance passage 26 with the transfer opposed roller 16c via the intermediate transfer belt 16.

The drum cleaner 17 is arranged at the right hand side in the FIGURE of the photosensitive drum 11 so as to be in contact therewith. In other words, the drum cleaner 17 is arranged outside the upper area of the photosensitive drum 11.

In short, in this embodiment, the black developing device 14, revolver 15, drum cleaner 17, and belt cleaner 22 are arranged outside the area above the photosensitive drum 11. In addition, in this embodiment, the intermediate transfer belt 16 is arranged above the photosensitive drum 11. Therefore, according to this embodiment, the developing agent undesirably scattered or leaking from the black developing device 14, revolver 15, drum cleaner 17, and belt cleaner 22 does not fall on the drum surface 11 or the intermediate transfer belt 16, thereby successfully preventing formation of a defective image due to deposition of the developing agent.

The paper-feed unit 6 has two paper-feed cassettes 26 and 28 stacked on top of the other. At the upper right end of each of the paper feed cassettes 26 and 28, a pick-up roller 31 is provided for picking up the top-end sheet P from the paper sheets stored in the cassette. A feed roller 32 and separate roller 33 are rotatably arranged in contact with each other at a position near the pick up roller 31 and downstream of the direction along which the paper sheet picked up by the pickup roller 31 is unloaded.

In the proximity to the right hand side of the paper feed cassettes 26 and 28 in the FIGURE, a vertical conveyance passage 26 is formed. The vertical conveyance passage 26 extends almost vertically upward through a secondary transfer region at which the intermediate transfer belt 16 and the secondary transfer roller 24 are arranged in contact with each other. On the vertical conveyance passage 26, a plurality of roller pairs 34 which rotate with a sheet P sandwiched between them, an aligning sensor 35 for detecting arrival of the sheet P, and an aligning roller pair 36 for feeding a paper sheet P to the secondary transfer region at a predetermined feed timing are arranged toward the secondary transfer region in the order mentioned above from below.

Furthermore, on the vertical conveyance passage 26 extending upward through the secondary transfer region, a fixing unit 38 is provided for fixing a developing agent image transferred on a sheet P by means of heat and pressure. The fixing unit 38 has a heating roller 38b having a built-in heater and a pressurizing roller 38a pressed against the heating roller 38b.

In shorts, in this embodiment, the vertical conveyance passage 26 is extended at the side of the photosensitive drum 11 farthest from the revolver 15, that is, though the area at the right hand side of and far from the photosensitive drum 11. In other words, the vertical conveyance passage 26 extends while passing through the area outside the lower portion of the black developing device 14, revolver 15, drum cleaner 17 and belt cleaner 22. With this arrangement, developing agents undesirably scattered from the black developing device 14 and the developing devices 15Y, 15M and 15C of the revolver 15 but also the developing agent undesirably leaking from the drum cleaner 17 and belt cleaner 22 can be prevented from falling and depositing on a paper sheet P.

The employment of the vertical conveyance passage 26 makes it possible not only to reduce the total size of the color-copying machine 1 but also to clear a paper-jam more easily. By the arrangement of the revolver 15 of a relatively large size at the left side of the photosensitive drum 11, the lengthwise size of the machine can be reduced. Owing to the presence of the vertical conveyance passage 26, the length of the conveyance passage of the paper sheet P can be reduced. As a result, the total size of the machine is successfully reduced. The vertical conveyance passage 26 near the secondary transfer region is easily exposed to open air outside the case 3 by opening the reverse unit 8 and a secondary transfer unit 50. With this structure, even if the paper jam occurs near the secondary transfer region, the paper jam can be easily cleared.

Now, an image forming operation by the color-copying machine 1 constructed as mentioned above will be explained.

As the initial operation, the black developing device 14 is moved down to separate it from the drum surface 11a and then the revolver 15 is rotated clockwise and the yellow developing device 15Y is placed so as to face the drum surface 11a. Furthermore, the belt cleaner 22 is rotated counterclockwise about a shaft 22a so as to separate from the intermediate transfer belt 16, and the secondary transfer roller 24 is moved in the direction (toward the right-hand side facing the FIGURE) away from the vertical conveyance passage 26 to separate from the intermediate transfer belt 16.

Subsequently, image data is read out from an original document (not shown) through the scanner unit 2 or image data is input from an external unit (not shown). Furthermore, the photosensitive drum 11 is rotated clockwise to uniformly charge the drum surface 11a to a predetermined potential by the charging unit 12. At this time, the intermediate transfer belt 16 is also rotated counterclockwise.

Further, based on color-separated yellow image data, the light exposure unit 13 is operated to form a yellow electrostatic latent image on the drum surface 11a. The exposure timing during this operation is obtained by detecting a detection mark (not shown) attached to the interior of the intermediate transfer belt 16 by a detector (not shown).

Subsequently, a yellow developing agent is supplied to the electrostatic latent image on the drum surface 11a through the yellow developing device 15Y to develop the yellow electrostatic latent image, thereby forming a yellow developing agent image on the drum surface 11a. The yellow developing agent image formed on the drum surface 11a is moved by rotation of the photosensitive drum 11 and passes through the primary transfer region adjacent to the intermediate transfer belt 16.

At this time, a bias potential having a reverse polarity to that of the yellow developing agent image is applied to the drum surface 11a via the primary transfer roller, thereby transferring the yellow developing agent image formed on the drum surface 11a onto the intermediate transfer belt 16. In this embodiment, since the length of the intermediate transfer belt 16 is set to be equal to an integral multiple of the outer circumference of the photosensitive drum 11, a developing agent image is always transferred onto the same position of the intermediate transfer belt 16 from the drum surface 11a.

After the yellow developing agent image is transferred onto the intermediate transfer belt 16, the residual yellow developing agent left on the drum surface 11a without being transferred is removed by the drum cleaner 17, and simultaneously, residual charge is removed from the drum surface 11a.

As a preparatory step for forming a next magenta electrostatic latent image on the drum surface 11a, the drum surface 11a is uniformly charged by the charging unit 12 and then the revolver 15 is rotated, thereby placing the magenta developing device 15M so as to face the drum surface 11a.

In this state, a series of processes as mentioned above, that is, light exposure→development→transfer on to the intermediate transfer belt 16, is performed. As a result, the magenta developing agent image is transferred and superposed onto the yellow developing agent image on the intermediate transfer belt 16. After the magenta developing agent image is transferred, a cyan developing agent image is superposed thereon in the same manner.

Subsequently, the revolver 15 is rotated to a home position, at which none of developing devices 15Y, 15M and 15C faces the drum surface 11a. Then, the black developing device 14 is moved up to face the drum surface 11a in place of the developing devices 15Y, 15M and 15C. In this state, the same series of processes as mentioned above is carried out to transfer a black developing agent image and superposes it on the yellow, magenta and cyan developing agent images on the intermediate transfer belt 16.

After all color development agent images are superposed on the intermediate transfer belt 16, the secondary transfer roller 24 is moved toward the left-hand side and brought into contact with the intermediate transfer belt 16 and the belt cleaner 22 is also brought into contact with the intermediate transfer belt 16. In this state, all color developing agent images superposed on the intermediate transfer belt 16 are moved by rotation of the intermediate transfer belt 16 to pass the secondary transfer region between the secondary transfer roller 24 and the intermediate transfer belt 16.

At this time, a paper sheet P that has been picked up from the cassette 26 or 28 by the pick-up roller 31 is conveyed through the vertical conveyance passage 26 upward by the conveyance roller pair 34. The paper sheet P is once aligned by the aligning roller 36, and then fed into the secondary transfer region at a predetermined timing.

Thereafter, when a bias potential having a reverse polarity to those of the developing agent images is applied to the intermediate transfer belt 16 via the secondary transfer roller 24, the superposed developing agent images on the intermediate transfer belt 16 are transferred on the paper sheet P. After the developing agent images are transferred onto the paper sheet P, the developing agent remaining on the intermediate transfer belt 16 is removed by the belt cleaner 22.The paper sheet P having all color developing agent images collectively transferred thereto is passed trough the fixing unit 38, heated and pressurized to thereby fix all color developing agent images on the paper sheet P. In this manner, a color image is formed. The paper sheet P having the color image formed thereon is then discharged onto a paper discharge tray 44 through a discharge roller 42 provided downstream of the fixing unit 38. In this embodiment, the paper discharge tray 44 is provided inside the case 3.

On the other hand, when an image is further formed on the rear side of the paper sheet P having a color image already formed on the other side thereof, the discharge roller 42 is rotated in an opposite direction while a rear edge of the paper sheet P (having an image on one surface) is held by the discharge roller 42. In this manner, the paper sheet P is conveyed in the opposite direction and loaded into the reverse unit 8. The paper sheet P loaded into the reverse unit 8 is conveyed downward by a plurality of conveyance roller pairs 46 and introduced into the nip of the aligning roller 36.

The paper sheet fed by hand through the manual feed unit 9 is picked up by the pick-up roller 49 and introduced into the nip of the aligning roller 36 by the feed roller 48.

According to this embodiment, the developing device and cleaner are not arranged above the photosensitive drum 11 and the intermediate transfer belt 16 which temporally holds a developing agent image. Therefore, undesirably scattered or leaking developing agent can be prevented from falling on the photosensitive drum 11 and intermediate transfer belt 16 to deposit thereon. By virtue of this, it is possible to prevent the formation of a defective image caused by deposition of the developing agent.

The paper sheet P is transferred through the vertical conveyance passage 26 passing through a discrete area at the right hand side of the photosensitive drum 11 in place of transferring the paper sheet P under the developing device and cleaner. With this structure, it is possible to prevent a developing agent from falling and depositing on the paper sheet P during conveyance. A defective image is not produced on the paper sheet P.

Since the vertical conveyance passage 26 is provided so as to pass near the reverse unit 8, which is detachably attached to the side surface of the case 3, it is possible to easily cope with a paper jam that occurs on the vertical conveyance passage 26. Incidentally, since the intermediate transfer belt 16 employed in this embodiment can be flexibly positioned, the secondary transfer region can be readily set on the vertical conveyance passage 26. By virtue of the structural arrangement, the length of the conveyance passage for the paper sheet P, which starts from the pickup of the paper sheet P and end with transferring and fixing a development image, can be minimized to an extremely short length.

To be more specific, by shortening the conveyance passage for the paper sheet P, occurrence of a paper jam can be reduced and the unit can be miniaturized.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

In the embodiment explained above, the yellow developing device 15Y, magenta developing device 15M, and cyan developing device 15C are arranged in the revolver 15 and the blackc developing device 14 is discretely arranged. However, the black developing device may be housed in the revolver 15.

1. An image forming apparatus comprising:
an image carrier on which a plurality of latent images are repeatedly formed;
a developing unit which houses a plurality of first developing devices, each containing a predetermined color developing agent, arranged side by side in a rotation direction, which is rotatably arranged such that said plurality of first developing devices are selectively placed so as to face the image carrier at a position outside an area above the image carrier, and which supplies a specific color developing agent to the latent image to develop the latent image;
a second developing device which is arranged so as to face the image carrier at a position outside said area and which supplies a predetermined color developing agent to the latent images to develop the latent images;
an intermediate transfer member which is arranged in contact with the image carrier and which superposes developing agent images developed by at least one of the first developing device and the second developing device and transfers the superposed developing agent image;
a conveying unit which conveys a transfer medium toward the intermediate transfer member; and
a transfer unit which transfers the superposed developing agent image transferred onto the intermediate transfer member to the transfer medium conveyed by the conveying unit.

2. The image forming apparatus according to claim 1, wherein said developing unit is in contact with a side of the image carrier and said second developing device is in contact with a lower portion of the image carrier.

3. The image forming apparatus according to claim 1, further comprising a cleaning unit which is arranged in contact with the image carrier at a position outside the aforementioned area, and which removes a residual developing agent left on the image carrier without being transferred on the intermediate transfer member.

4. The image forming apparatus according to claim 1, wherein said intermediate transfer member is in contact with an upper portion of the image carrier.

5. The image forming apparatus according to claim 4, wherein said image carrier is a virtually cylindrical photosensitive drum and said intermediate transfer member is an endless intermediate transfer belt having an integral multiple length of an outer circumference of the photosensitive drum.

6. The image forming apparatus according to claim 3, wherein said conveying unit has a conveyance passage extending along a position outside an area below the developing unit, second developing device and cleaning unit.

7. An image forming apparatus comprising:
an image carrier of virtually cylindrical form on an outer circumference surface of which a latent image is to be formed;
a developing device which is arranged at a position outside an area above the image carrier so as to face the outer circumference surface of the image carrier and which supplies a developing agent to the latent image to develop the latent image;
an endless intermediate transfer belt which is rotatably arranged above and in contact with the outer circumference surface of the image carrier and which transfers a developing agent image developed by the developing device;
a conveying unit which conveys a transfer medium toward the intermediate transfer belt; and
a transfer unit which transfers the developing agent image transferred on the intermediate transfer belt to the transfer medium conveyed by the conveying unit.

8. The image forming apparatus according to claim 7, further comprising a cleaning unit which is arranged in contact with the intermediate transfer belt at a position outside the aforementioned area, and which removes a residual developing agent left on the intermediate transfer belt without being transferred on the transfer medium conveyed by the conveying unit.

9. The image forming apparatus according to claim 7, wherein said intermediate transfer belt has an integral multiple length of the outer circumference of the image carrier.

10. The image forming apparatus according to claim 8, wherein said conveying unit has a conveyance passage extending through a position outside an area below the developing device and cleaning unit.

11. The image forming apparatus according to claim 10, wherein said intermediate belt is rotatably arranged in contact with the conveyance passage.

12. The image forming apparatus according to claim 11, wherein said conveyance passage is vertically extended at a side of the image carrier.

13. An image forming apparatus comprising:
an image carrier on which a plurality of latent images are repeatedly formed;
a developing unit which houses a plurality of developing devices, each containing a predetermined color developing agent, arranged side by side in a rotation direction, which is rotatably arranged such that said plurality of developing devices are selectively placed so as to face a side of the image carrier, and which supplies a specific color developing agent to the latent image to develop the latent image;
an endless intermediate transfer belt which is arranged above and in contact with the image carrier and which superposes development agent images developed by the developing unit and transfers the superposed development agent image;
a conveying unit which conveys a transfer medium toward the intermediate transfer belt through a conveyance passage vertically extended at an opposite side of the image carrier to the developing unit; and
a transfer unit which transfers the superposed developing agent image transferred on the intermediate transfer belt to the transfer medium conveyed through the conveyance passage.

14. The image forming apparatus according to claim 13, wherein said image carrier is a virtually cylindrical photosensitive drum and said intermediate transfer belt has an integral multiple length of an outer circumference of the photosensitive drum and is arranged in contact with the conveyance passage.

15. The image forming apparatus according to claim 14, further comprising a case housing the image carrier, developing unit, intermediate transfer belt, conveying unit, and transfer unit, wherein a side surface of the case is equipped with a detachable unit which allows to expose the conveyance passage to open air.

16. The image forming apparatus according to claim 15, wherein said detachable unit is a reverse unit for reversing the transfer medium conveyed through the conveyance passage.
